(19) United States
(12) Patent Application Publication
(10) Pub. No.: US 2005/0157874 A1
(43) Pub. Date: Jul. 21, 2005

(54) Cryptography for secure dynamic group communications

(75) Inventors: Emmanuel Bresson, Bruz (FR); Olivier Chevassut, Oakland, CA (US); David Pointcheval, Thiais (FR)

Correspondence Address: LAWRENCE BERKELEY NATIONAL LABORATORY, ONE CYCLOTRON ROAD, MAIL STOP 90B, UNIVERSITY OF CALIFORNIA, BERKELEY, CA, 94720, US

(73) Assignee: The Regents of the University of California

(21) Appl. No.: 11/001,251

(22) Filed: Nov. 30, 2004

Related U.S. Application Data
(60) Provisional application No. 60/526,301, filed on Dec. 1, 2003.

(51) Int. Cl. H04K 1/00; H04L 9/00

(52) U.S. Cl. 380/30; 380/283; 380/285; 713/171

(57) ABSTRACT

A method for generating a cryptographic key by players in a dynamic group, where:
1) a first player U₁ initiates an upflow to the next player, the upflow based on a random value x₁, a random value v₁, and “g”, a generator of a finite cyclic group where a computational solution to a Diffie-Hellman problem is hard;
2) each player after the first Uₚ sends an upflow Flₚ, comprising information based on a random value xₚ, a random value vₚ, and the previous upflow Flₚ₋₁;
3) the last player Uₚ sends a downflow Flₙ to all other players in the dynamic group, where the downflow Flₙ comprises information based on a random value xₙ, a random value vₙ, and the previous upflow Flₙ₋₁. New players may join the dynamic group in a similar fashion. Players may be removed from the dynamic group by adjusting the downflow to the remaining players. The dynamic group may be refreshed by adjusting the downflow to establish a new cryptographic key.

### CROSS REFERENCE TO RELATED APPLICATIONS

This application claims benefit of priority to U.S. provisional patent application 60/526,301, “Cryptography for secure dynamic group communications: method, apparatus, and signal”, filed Dec. 1, 2003.

### STATEMENT REGARDING FEDERAL FUNDING

This invention was made with U.S. Government support under Contract Number DE-AC03-76SF00098 between the U.S. Department of Energy and The Regents of the University of California for the management and operation of the Lawrence Berkeley National Laboratory. The U.S. Government has certain rights in this invention.

### REFERENCE TO A COMPUTER PROGRAM

Not Applicable.

### BACKGROUND OF THE INVENTION

1. Field of the Invention

The present invention relates to provably secure communications, and more particularly relates to secure communications among dynamic groups.

2. Description of the Relevant Art

U.S. Pat. No. 5,241,599, hereby incorporated by reference, discloses a method which permits computer users to authenticate themselves to a computer system without requiring that the computer system keep confidential the password files used to authenticate the respective user's identities. The U.S. Pat. No. 5,440,635 invention is useful in that it prevents a compromised password file from being leveraged by crafty hackers to penetrate the computer system.

U.S. Pat. No. 5,440,635, hereby incorporated by reference, discloses a cryptographic communication system, which employs a combination of public and private key cryptography, allowing two players, who share only a relatively insecure password, to bootstrap a computationally secure cryptographic system over an insecure network. The U.S. Pat. No. 5,440,635 system is secure against active and passive attacks, and has the property that the password is protected against offline “dictionary” attacks.

U.S. Pat. No. 6,226,383, hereby incorporated by reference, discloses a cryptographic method, where two players use a small shared secret (S) to mutually authenticate one another other over an insecure network. The U.S. Pat. No. 6,226,383 methods are secure against off-line dictionary attack and incorporate an otherwise unauthenticated public key distribution system.

One major difficulty with the preceding patents, and other representative technology, is that none of them scale very well to groups of more than two players intercommunicating with a secure encrypted method which is provably secure.

Publication “Group Diffie-Hellman Key Exchange Secure Against Dictionary Attacks” by Bresson, Chevassut, and Pointcheval, hereby incorporated by reference, discloses a cryptographic communication system, which may be secure against “dictionary” attacks.

Publication “Mutual Authentication and Group Key Exchange for Low-Power Mobile Devices” by Bresson, Chevassut, Essiari, and Pointcheval, hereby incorporated by reference, discloses a cryptographic communication system for low computational power devices.

Web pages from mathworld.wolfram.com downloaded on Nov. 21, 2003 describing the terms “Finite Group”, “Cyclic Group”, “Group Order”, “Group”, “Abelian Group”, and “Identity Element” are hereby incorporated by reference. These pages describe the mathematics behind the concept of a finite cyclic group with prime generator “g”.

### BRIEF SUMMARY OF THE INVENTION

This invention provides for a method for generating a cryptographic key by a player in a dynamic group, the method comprising: receiving, by a player Uₚ in a dynamic group with a first player U₁ and a last player Uₙ, where p>1, a previous upflow Flₚ₋₁ from a previous player Uₚ₋₁ in the dynamic group; player Uₚ selecting a random value xₚ, and a random value vₚ; and player Uₚ sending an outflow Flₚ, comprising information based on the random value xₚ, the random value vₚ, and the previous upflow Flₚ₋₁. The first player U₁ may be a process on a computer that seeks to initiate a dynamic group, that in turn communicates with U₂ who may be either a user on the same computer, or another process on the same computer. In this instance, the last player, Uₙ would be a third or greater player. Dynamic groups of players may variously have size ranges from 1-2, 1-3, 3-20, 1-100, 1-1000 or more. Specifically, dynamic groups may initiate with 3 or more players, with subsequent departure of players, resulting in a dynamic group of 2 players. Similarly, dynamic groups may initiate with a single player, increasing to a dynamic group of 2 players may subsequently increase or decrease in number.

The method for generating a cryptographic key by a player in the dynamic group of paragraph [0012], may further comprise: for a first player U₁ in the dynamic group: player Uₚ selecting a random value x₁, and a random value v₁; setting an initial upflow Fl₁ comprising information based on the random value x₁, the random value v₁, and “g”, a generator of a finite cyclic group where a computational solution to a Diffie-Hellman problem is hard.

In the method for generating a cryptographic key by a player in the dynamic group of paragraph [0013], the sending step may further comprise: when player Uₚ is not the last player in the dynamic group, then: player Uₚ sending an upflow Flₚ to a subsequent player Uₚ₊₁ in the dynamic group, the upflow Flₚ comprising the outflow Flₚ; when player Uₚ is the last player in the dynamic group, then: player Uₚ sending a downflow Flₙ to all other players in the dynamic group, the downflow Flₙ comprising the outflow Flₚ.

In the method for generating a cryptographic key by a player in the dynamic group above, one or more players may be deleted by steps comprising: forming a set of L players, U_{L}, leaving the dynamic group; forming a set of R players, U_{R}, remaining in the dynamic group; choosing a controller U_{C} from the remaining set of R players U_{R}; inputting, by controller U_{C}, the downflow Flₙ, where the downflow Flₙ has one entry associated with each player in the dynamic group; and sending a controller U_{C} downflow signal Fl′_{C}, comprising: controller U_{C} sending the controller downflow Fl′_{C} based upon a random value x_{C}, a random value v_{C}, and the downflow signal Flₙ, where each entry associated with the set of L players U_{L} leaving in the downflow signal Flₙ has been deleted.

In the method for generating a cryptographic key by a player in the dynamic group above, one ore more players may be added by steps comprising: forming a set of J players to form a larger dynamic gropu U₁, . . . Uₙ, Uₙ₋₁, . . . , Uₙ₊ₖ, . . . , U_{n+J}, where 1≦k≦J; sending an upflow Flₙ₊ₖ from each player Uₙ₊ₖ, to player Uₙ₊ₖ₊₁, where 1≦k<J−1, said upflow Flₙ₊ₖ based upon a random value xₙ₊ₖ, a random value vₙ₊ₖ, and the upflow Flₙ₊ₖ₋₁, received from player Uₙ₊ₖ₋₁; and sending a downflow Fl_{n+J} by player U_{n+J}, based upon a random value x_{n+J}, a random value v_{n+J}, and the upflow Flₙ₊ⱼ₋₁.

In the method for generating a cryptographic key by a player in the dynamic group above, all players may be refreshed with a new cryptographic key by steps comprising: choosing a refresher Uᵣ from the dynamic group U₁, . . . Uₙ; inputting, by refresher Uᵣ, the downflow Flₙ, where the downflow Flₙ has one entry associated with each player in the dynamic group; and sending, by refresher Uᵣ, a refresher Uᵣ downflow Fl′ᵣ′ based upon a random value xᵣ, a random value vᵣ, and the downflow signal Flₙ.

In the methods above for generating a cryptographic key wherein said upflows may be encrypted with a first encryption method. Alternatively, the downflows may be encrypted with a second encryption method, or still, both upflows and downflows may be encrypted with a single encryption method. Outflows may also be encrypted by either the first, second, or an entirely different encryption method. Any of these encryption methods may be based on symmetric-key, elliptic curve symmetric-key, or public key encryption methods.

### BRIEF DESCRIPTION OF THE SEVERAL VIEWS OF THE DRAWINGS

The invention will be more fully understood by reference to the following drawings, which are for illustrative purposes only:

FIG. 1A is a schematic of the flows involved in a secure dynamic group of four players.

FIG. 1B is a schematic of the flows involved in a secure dynamic group of four players where player two has been deleted, and player four has been designated as the group controller.

FIG. 1C is a schematic of the flows involved in a secure dynamic group of four players where player two has been deleted, and player three has been designated as the group controller.

FIG. 2A is a schematic of the flows involved in a secure dynamic group of two players.

FIG. 2B is a schematic of the flows involved in a secure dynamic group of two players adding another two players.

FIG. 3 is a schematic of three secure dynamic groups in communication through players who are members of two of the groups.

### DETAILED DESCRIPTION OF THE PREFERRED EMBODIMENT

Definitions

“Computer” means any device capable of performing the steps, methods, or producing signals as described herein, including but not limited to: a microprocessor, a microcontroller, a digital state machine, a field programmable gate array (FGPA), a digital signal processor, a collocated integrated memory system with microprocessor and analog or digital output device, a distributed memory system with microprocessor and analog or digital output device connected by digital or analog signal protocols.

“Computer readable media” means any source of organized information that may be processed by a computer to perform the steps described herein to result in, store, perform logical operations upon, or transmit, a flow or a signal flow, including but not limited to: random access memory (RAM), read only memory (ROM), a magnetically readable storage system; optically readable storage media such as punch cards or printed matter readable by direct methods or methods of optical character recognition; other optical storage media such as a compact disc (CD), a digital versatile disc (DVD), a rewritable CD and/or DVD; electrically readable media such as programmable read only memories (PROMs), electrically erasable programmable read only memories (EEPROMs), field programmable gate arrays (FGPAs), flash random access memory (flash RAM); and information transmitted by electromagnetic or optical methods including, but not limited to, wireless transmission, copper wires, and optical fibers.

“Player” means any person using, or any computer process residing, on a client or server computer. Multiple players may reside on the same or different computers, and multiple instances of a control process or person may be so designated.

“Dynamic Group” means a collection of players communicating together, where one or more players may be added or deleted singly or in subgroups.

“Finite Group” means a group of finite order n defined by an element g, the group generator, and its n powers, up to gⁿ=I, where I is the identity element. Further details regarding group theory, finite, and finite cyclic groups, may be obtained in mathematical treatises on algebraic group theory.

Secure Group Encryption Setup

One aspect of this invention is a secure group setup protocol. In this aspect, an initial static group of players desire to exchange a cryptographic key using a group password pw, which is known to all players. Initially, a base “g” is chosen, where “g” is a generator of a finite cyclic group. Generator “g” is additionally a high order prime number chosen so as to make a solution of the Diffie-Hellman problem computationally hard.

A plurality of players U₁, . . . Uⱼ, . . . , Uₙ, where 1≦j≦n are defined to be players Uⱼ of the n players comprising a secure group.

The secure group is set up in the following manner. A first player, U₁, uses a generator “g”, selects a random value x₁, and a random value v₁. Player U₁ then sends an initial upflow signal Fl₁ from player U₁ to player U₂, where the initial upflow signal Fl₁ is based upon generator “g”, the random value χ₁, and the random value v₁.

Similarly, for player U₂ through player Uₙ₋₁, each player Uⱼ selects a random value χⱼ, and a random value vⱼ. Player Uⱼ then sends an upflow signal Flⱼ from player Uⱼ to player Uⱼ₊₁. The upflow signal Flⱼ includes information based upon the preceding player Uⱼ₋₁ upflow Flⱼ₋₁, the random value χⱼ, and the random value vⱼ.

In a functionally equivalent manner, the preceding method describing the steps from player U₂ to player Uₙ₋₁ may instead be taken as though from player U₁ through player Uₙ₋₁ by the simple expedient of setting Fl₀ to be the generator “g”.

The final player, Uₙ, takes as an input the preceding player Uₙ₋₁ upflow Flₙ₋₁. Player Uₙ selects a random value χₙ, and a random value vₙ. Player Uₙ then broadcasts a downflow signal Flₙ to the remaining players (also known as a multicast when substantially simultaneously broadcast to multiple players) in the plurality of players U₁ . . . Uₙ₋₁. Downflow signal Flₙ includes information based upon the preceding player Uₙ₋₁ upflow Flₙ₋₁, the random value χₙ, and the random value vₙ.

Once a player Uⱼ has received the downflow signal Flₙ, player Uⱼ may calculate a cryptographic key for use in secure group communications based on the downflow signal Flₙ, and its previously selected random value χⱼ. At this point, player Uⱼ may be thought of as having connected to the group.

In the description above, the upflows may be unencrypted, encrypted by a first encryption method, or indeed encrypted with a different encryption method between each successive player Uⱼ to Uⱼ₊₁. Similarly, the downflow may be encrypted with a second encryption method, the same first encryption method, or indeed no encryption whatsoever. At this time, the literature has shown proof of security where the upflows and downflow are protected by encryption methods. Examples of such encryption methods include, but are not limited to, the Diffie-Hellman key exchange method, elliptic curve-based Diffie-Hellman methods, public key encryption methods, etc.

Detailed Description of the Flows

Each flow sent from a player Uⱼ is dependent on the incoming upflow Uⱼ₋₁, and the two selected random values χⱼ and vⱼ, with the understanding that Fl₀ is comprised of generator “g”. Table 1 below demonstrates this previous player dependency for a simple example case of four players:

TABLE 1
Flows Associated With Four Players

| | | | | |
|---|---|---|---|---|
| Fl₀ | g | | | |
| Fl₁ | g^{ν}^{₁} | g^{ν}^{₁}^{χ}^{₁} | | |
| Fl₂ | g^{ν}^{₁}^{ν}^{₂}^{χ}^{₂} | g^{ν}^{₁}^{ν}^{₂}^{χ}^{₁} | g^{ν}^{₁}^{ν}^{₂}^{χ}^{₁}^{χ}^{₂} | |
| Fl₃ | g^{ν}^{₁}^{ν}^{₂}^{ν}^{₃}^{χ}^{₂}^{χ}^{₃} | g^{ν}^{₁}^{ν}^{₂}^{ν}^{₃}^{χ}^{₁}^{χ}^{₃} | g^{ν}^{₁}^{ν}^{₂}^{ν}^{₃}^{χ}^{₁}^{χ}^{₂} | g^{ν}^{₁}^{ν}^{₂}^{ν}^{₃}^{χ}^{₁}^{χ}^{₂}^{χ}^{₃} |
| Fl₄ | g^{ν}^{₁}^{ν}^{₂}^{ν}^{₃}^{ν}^{₄}^{χ}^{₂}^{χ}^{₃}^{χ}^{₄} | g^{ν}^{₁}^{ν}^{₂}^{ν}^{₃}^{ν}^{₄}^{χ}^{₁}^{χ}^{₃}^{χ}^{₄} | g^{ν}^{₁}^{ν}^{₂}^{ν}^{₃}^{ν}^{₄}^{χ}^{₁}^{χ}^{₂}^{χ}^{₄} | g^{ν}^{₁}^{ν}^{₂}^{ν}^{₃}^{ν}^{₄}^{χ}^{₁}^{χ}^{₂}^{χ}^{₃} |
| Term | β₁ | β₂ | β₃ | β₄ |
| → | | | | |

In Table 1 above, each term β₁ . . . β₄ in each flow is a single-valued number evaluated by exponentiation of the generator “g” as indicated. Thus, Fl₃ can be seen to have four numbers. Each of the players U₁ . . . U₄ may have the downflow Fl₄ sent to them in either a sequential or a multicast manner. Additionally, U₄ may also send the downflow Fl₄ to itself should that be advantageous.

Each of the players Uₖ at this point has available to it a term βₖ in the downflow Fl₄ corresponding to player Uₖ, as well as its previously selected random value χₖ. A cryptographic key is generated by raising the term βₖ corresponding to the player Uₖ in the downflow to the power χₖ.

As an example, still referring to Table 1 above, player U₁ has term β₁ in the downflow of g^{v}^{₁}^{v}^{₂}^{v}^{₃}^{v}^{₄}^{χ}^{₁}^{χ}^{₂}^{χ}^{₃}^{χ}^{₄}, notably without any χ₁ exponent. By raising β₁ to the χ₁ power, we obtain (g^{v}^{₁}^{v}^{₂}^{v}^{₃}^{v}^{₄}^{χ}^{₁}^{χ}^{₂}^{χ}^{₃}^{χ}^{₄})^{χ}^{₁}, or more simply g^{v}^{₁}^{v}^{₂}^{v}^{₃}^{v}^{₄}^{χ}^{₁}^{χ}^{₂}^{χ}^{₃}^{χ}^{₄}, which is the cryptographic key for player U₁, and indeed, all of the other players U₁ . . . U₄. Thus, all players have the same cryptographic key, and may commence communications with the key using Data Encryption Standard (DES), Advanced Encryption Standard (AES), or other encryption method, based upon the cryptographic key. From the cryptographic key g^{v}^{₁}^{v}^{₂}^{v}^{₃}^{v}^{₄}^{χ}^{₁}^{χ}^{₂}^{χ}^{₃}^{χ}^{₄}, a session key may be calculated.

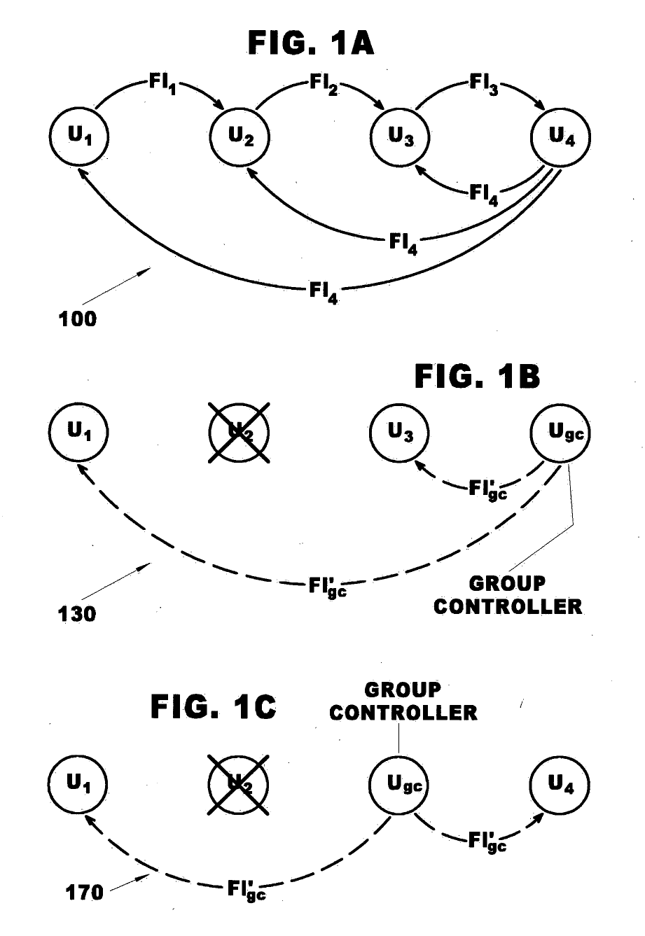

Refer now to FIG. 1A, which depicts the setup phase of the four players described previously in Table 1. Flow Fl₁ originates with player U₁, and is propagated to player U₂. Similarly, player U₂ originates flow Fl₂, which is propagated to player U₃, and U₃ originates flow Fl₃, which is propagated to player U₄. U₄ is shown as either sequentially broadcasting the downflow Fl₄ to players U₁, U₂, and U₃, or simultaneously multicasting the downflow Fl₄ to players U₁, U₂, and U₃. When a player U₁, U₂, and U₃ receives the downflow Fl₄ and has generated the cryptographic key for a secure group session, the secure group 100 is established, and is ready for intragroup secure communication.

Secure Group Deletion

As may also be observed from Table 1 above, no term in any of the flows Fl₁ . . . Fl₄ is repeated, and each flow term βₖ is distinct. This distinctiveness property increases the difficulty of “cracking” the secure group cryptographic key, as none of the data values are repeated. Note that for each of the players Uₖ where k=1 . . . 4, none of the flow terms βₖ vertically above player Uₖ contains any exponentiation using χₖ.

To delete a player Uⱼ, the downflow (in this example Fl₄) has the term βⱼ associated with the player Uⱼ deleted. Additionally, one of the remaining players is designated as the group controller (denoted “gc” in subscripts). After the downflow has been redacted of the one or more players leaving the group, the group controller selects a new random value χ_{gc}, and a new random value v_{gc}. Using the previously obtained random values χ_{gc} and v_{gc} used to enter the secure group, the resulting redacted flow is adjusted by raising each remaining term βⱼ having exponent χ_{gc}, to the power

$$\frac{{χ}_{gc}^{′} {v}_{gc}^{′}}{{χ}_{gc} {v}_{gc}} .$$

For each remaining term βⱼ not having an exponent term containing χ_{gc}, (i.e. where j=gc) the redacted flow term βⱼ is adjusted by being exponentiated to the power

$$\frac{{v}_{gc}^{′}}{{v}_{gc}} .$$

The group controller may be chosen arbitrarily, but may also be chosen for reasons of security, computational power, logistical reasons, or convenience.

Refer now to Table 2 below, where, as an example, player U₂ is leaving the original four player secure group session described above. The group controller, here taken as player U₄, selects new values χ′₄, and a new random value v₄′, and adjusts the redacted downflow Fl₄₋₂. The Fl′₄₋₂ notation reflects a new-flow including information based on the original downflow Fl₄ with player U₂ having been removed.

TABLE 2
Four Original Players With Player Two Redacted

| | | | | |
|---|---|---|---|---|
| Fl₄ original | g^{ν}^{₁}^{ν}^{₂}^{ν}^{₃}^{ν}^{₄}^{χ}^{₂}^{χ}^{₃}^{χ}^{₄} | g^{ν}^{₁}^{ν}^{₂}^{ν}^{₃}^{ν}^{₄}^{χ}^{₁}^{χ}^{₃}^{χ}^{₄} | g^{ν}^{₁}^{ν}^{₂}^{ν}^{₃}^{ν}^{₄}^{χ}^{₁}^{χ}^{₂}^{χ}^{₄} | g^{ν}^{₁}^{ν}^{₂}^{ν}^{₃}^{ν}^{₄}^{χ}^{₁}^{χ}^{₂}^{χ}^{₃} |
| Fl₄₋₂ redacted | g^{ν}^{₁}^{ν}^{₂}^{ν}^{₃}^{ν}^{₄}^{χ}^{₂}^{χ}^{₃}^{χ}^{₄} | g^{ν}^{₁}^{ν}^{₂}^{ν}^{₃}^{ν}^{₄}^{χ}^{₁}^{χ}^{₃}^{χ}^{₄} | g^{ν}^{₁}^{ν}^{₂}^{ν}^{₃}^{ν}^{₄}^{χ}^{₁}^{χ}^{₂}^{χ}^{₄} | g^{ν}^{₁}^{ν}^{₂}^{ν}^{₃}^{ν}^{₄}^{χ}^{₁}^{χ}^{₂}^{χ}^{₃} |
| Fl′₄₋₂ redacted | g^{ν}^{₁}^{ν}^{₂}^{ν}^{₃}^{ν′}^{₄}^{χ}^{₂}^{χ}^{₃}^{χ′}^{₄} | g^{ν}^{₁}^{ν}^{₂}^{ν}^{₃}^{ν}^{₄}^{χ}^{₁}^{χ}^{₃}^{χ}^{₄} | g^{ν}^{₁}^{ν}^{₂}^{ν}^{₃}^{ν′}^{₄}^{χ}^{₁}^{χ}^{₂}^{χ′}^{₄} | g^{ν}^{₁}^{ν}^{₂}^{ν}^{₃}^{ν′}^{₄}^{χ}^{₁}^{χ}^{₂}^{χ}^{₃} |
| Player → | U₁ | U₂ | U₃ | U₄ |
| Term → | β₁ | β₂ | β₃ | β₄ |

The deleted secure dynamic group that results is shown below, and denoted with primes to indicate the change in the group state. This updated state is then broadcast to the remaining group players.

Note that in this example, redaction is conceptually indicated by crossing out the cell containing the corresponding term in Table 2. While actual deletion of the corresponding term in the redacted outflow Fl₄₋₂ is one option for forming the redacted outflow Fl′₄₋₂, it may also be formed by simply outputting the other terms of the redacted outflow, and skipping over the term(s) corresponding to the player(s) being deleted. Restating this, in the skipping method, the term β₂ is never actually deleted, merely skipped over and not included in the downflow Fl′₄₋₂. In either event, Table 3 shows the resulting downflow Fl′₄₋₂ terms comprising the actual flow.

TABLE 3
Multicast Resulting From Four Original Players
With Player Two Redacted

| | | | |
|---|---|---|---|
| Fl′₄₋₂ | g^{ν}^{₁}^{ν}^{₂}^{ν}^{₃}^{ν′}^{₄}^{χ}^{₂}^{χ}^{₃}^{χ′}^{₄} | g^{ν}^{₁}^{ν}^{₂}^{ν}^{₃}^{ν′}^{₄}^{χ}^{₁}^{χ}^{₂}^{χ′}^{₄} | g^{ν}^{₁}^{ν}^{₂}^{ν}^{₃}^{ν′}^{₄}^{χ}^{₁}^{χ}^{₂}^{χ}^{₃} |
| Player′→ | U′₁ | U′₃ | U′₄ |

Refer now to FIG. 1B, which graphically indicates the removal of player U₂ previously described in Tables 2 and 3. In this case, player U₄ has been designated as the group controller, and been renamed as U_{gc}. The adjusted downflow, having player U₂ redacted, is denoted Fl′_{gc}, which is either sequentially or simultaneously broadcast to players U₁ and U₃. Once a player has received the adjusted downflow Fl′_{gc} and has calculated a new cryptographic key, intragroup communications may be either commenced or resumed in the redacted group 130.

Refer now to FIG. 1C, which graphically indicates the removal of player U₂. In this case, player U₃ has been designated as the group controller, and been renamed as U_{gc}. The adjusted downflow, having player U₂ redacted, is again denoted Fl′_{gc}, which is either sequentially or simultaneously broadcast to players U₁ and U₄. Once a player has received the adjusted downflow Fl′_{gc} and has calculated a new cryptographic key, intragroup communications may be either commenced or resumed in the redacted group 170. The resulting group 170 is functionally equivalent to group 130 described above in FIG. 1B, with the exception that the cryptographic key and downflow Fl′_{gc} terms will be entirely different.

In the example above, player U₂ has been shown as actually removed. In practice, the player(s) being removed need just be skipped over in the multicast updated flow. After a player determines that it is no longer a member of the secure group, it would preferably delete all references and data relating to the group. As implied, this process may be used for several players leaving a dynamic secure group simultaneously, with the proviso that at least one player remain in the dynamic secure group. Additionally, the removal steps may be combined with the joining operations described below.

Secure Group Refresh

It may readily be seen that in the trivial case where no party is leaving, the previous steps of selecting a group controller, picking new random values for the group controller, and updating the downflow to the other group members has the effect of refreshing all downflow terms, and thereby refreshing the cryptographic key. Insofar as a hacker trying to break the cryptographic key, this has the effect of starting the attack all over, with no history whatsoever. This refresh technique may be useful if it appears that the secure group is under attack, or if there have been a number of unsuccessful joining events (joining is described below).

Secure Group Joining

Generally speaking, a set of J new players may join an existing plurality of players U₁ . . . Uₙ to form an expanded plurality of players U₁ . . . Uₙ, Uₙ₊₁ . . . Uₙ₊ₖ . . . U_{n+J}, where 1≦k≦J. In this process, one or more players are added to an ongoing group of players U₁ . . . Uₙ, so that both the existing and new players may communicate among the expanded secure group.

A method used to join new players Uₙ₊ₖ, . . . , U_{n+J}, where 1≦k≦J to an existing group U₁ . . . Uₙ of n players comprises choosing one of the existing group players to act as a group controller U_{gc}. The group controller has available to it the initial group downflow Flₙ, as do all players of the initial group. The group controller U_{gc} selects a new value χ_{gc}′, a new random value v_{gc}′, and adjusts the initial downflow with the new χ_{gc}′ and v_{gc}′, values. As the initial downflow Flₙ is adjusted, the cryptographic key term missing from the initial flow is added. The resulting adjusted flow Fl′_{gc} is then sent to the first new player Uₙ₊₁, in the expanded secure group.

For players Uₙ₊₁ through player U_{n+J-1}, each player Uₙ₊ₖ selects a random value χₙ₊ₖ, and a random value vₙ₊ₖ. Player Uₙ₊ₖ then sends an upflow signal Fl′ₙ₊ₖ from player Uₙ₊ₖ to player Uₙ₊ₖ₊₁. The upflow signal Fl′ₙ₊ₖ comprises information based upon the preceding player Uₙ₊ₖ₋₁ upflow Fl′ₙ₊ₖ₋₁, the random value χₙ₊ₖ, and the random value vₙ₊ₖ.

The final player in the expanded group, U_{n+J}, takes as an input the preceding player U_{n+J-1} upflow Fl′_{n+J-1}. Player U_{n+J} selects a random value χ_{n+J}, and a random value v_{n+J}. Player U_{n+J} then broadcasts a downflow signal Fl′_{n+J} to the remaining players (also known as a multicast) in the expanded plurality of players U₁, . . . Uₙ, Uₙ₊₁, . . . , Uₙ₊ₖ, . . . , U_{n+J}, where 1≦k≦J−1. Downflow signal Fl′_{n+J} comprises information based upon the preceding player U_{n+J-1} upflow Fl′_{n+J-1}, the random value χ_{n+J}, and the random value v_{n+J}. Broadcast from the final player U_{n+J} in the expanded group to itself if not necessary, but may also be done.

Once a player Uⱼ has received the downflow signal Fl′_{n+J}, player Uⱼ may calculate a cryptographic key for use in secure group communications based on the downflow signal Fl′_{n+J}, and its previously selected random value χⱼ.

In the description above, as with the initial setup of the secure group, the upflows may be unencrypted, encrypted by a first encryption method, or indeed encrypted with a different encryption method between each successive player Uⱼ to Uⱼ₊₁.

Similarly, the downflow may be encrypted with a second encryption method, the same first encryption method, or indeed no encryption whatsoever. At this time, the literature has shown proof of security where the upflows and downflow are protected by symmetric key encryption methods. Examples of such symmetric key encryption methods include the Diffie-Hellman method, elliptic curve-based Diffie-Hellman methods, etc.

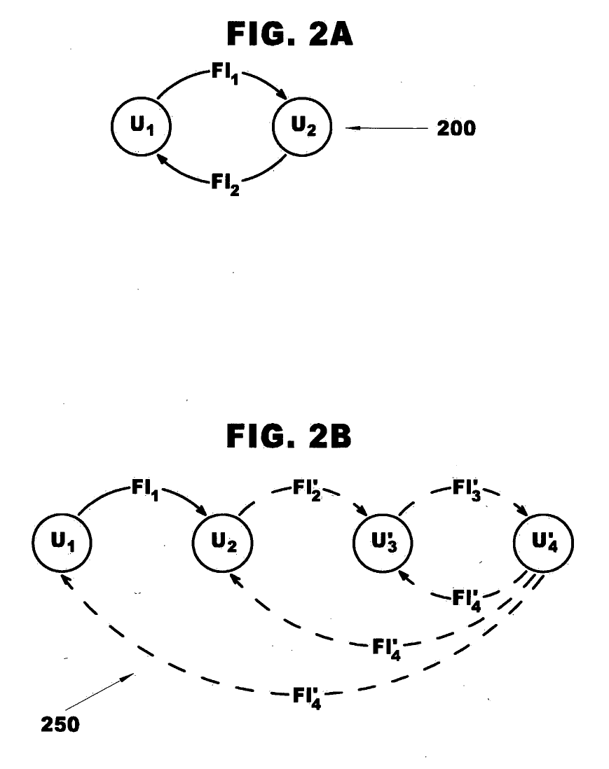

The method described above for forming an expanded group is likely easier to understand with an example. Refer now to FIGS. 2A, 2B, and Table 4, which illustrate the steps and flows involved in expanding a secure group of two players to a secure group of four players.

In FIG. 2A, we see an initial secure group 200 comprised of two players U₁ and U₂. In this very simple example Fl₁ player U₁ transmits an upflow Fl₁ to player U₂. Player U₂ responds by in turn transmitting a downflow Fl₂ to player U₁. After both players have calculated the cryptographic key, secure communications may commence between them.

Table 4 details the two flows between players U₁ and U₂ that comprise this initial secure group 200 with Fl₁ and Fl₂. In this example, the two flows comprise two exponentiated terms. As usual, the zeroth flow Fl₀ is set to comprise g.

FIG. 2B indicates the addition of two more players to the secure group, forming a secure group 250 comprising four players: U₁, U₂, U′₃ and U′₄. All new components in this Figure are reflected with primed notation. Thus, we see that players U′₃, U′₄, and flows Fl′₂, Fl′₃, and Fl′₃ are new. In this example, player U₂ is designated as the group controller.

Player U₂ forms the adjusted flow, denoted as “Fl′₂ Adjusted” comprising information based on a new random value χ′₂, a new random value v′₂, and the previous downflow Fl₂, denoted in Table 4 as “Fl₂ Initial”. Player U₂, acting as the group controller, then sends an upflow signal Fl′₃ to player U′₃. Player U′₃ then forms a new upflow, Fl′₃, comprising information based on a random value χ′₃, a random value v′₃, and the previous upflow “Fl′₂ Adjusted”. Player U′₃ then sends upflow signal Fl′₃ to player U′₄.

Player U′₄ then forms a new downflow, Fl′₄, comprising information based on a random value χ′₄, a random value v′₄, and the previous upflow Fl′₃. Player U′₄ then sends downflow signal Fl′₄ to players U₁, U₂, and U′₃. When players U₁, U₂, and U′₃ receive the downflow signal Fl′₄, they may then use their private exponent values of χ to calculate the cryptographic key.

TABLE 4
Flows Associated With Two Players Joining An Initial Two Players

| | | | | |
|---|---|---|---|---|
| Fl₀ | g | | | |
| Fl₁ | g^{ν}^{₁} | g^{ν}^{₁}^{χ}^{₁} | | |
| Fl₂ Initial | g^{ν}^{₁}^{ν}^{₂}^{χ}^{₂} | g^{ν}^{₁}^{ν}^{₂}^{χ}^{₁} | | |
| Fl′₂ | g^{ν}^{₁}^{ν′}^{₂}^{χ′}^{₂} | g^{ν}^{₁}^{ν′}^{₂}^{χ}^{₁} | g^{ν}^{₁}^{ν′}^{₂}^{χ}^{₁}^{χ′}^{₂} | |
| Adjusted | | | | |
| Fl′₃ | g^{ν}^{₁}^{ν′}^{₂}^{ν′}^{₃}^{χ′}^{₂}^{χ′}^{₃} | g^{ν}^{₁}^{ν′}^{₂}^{ν′}^{₃}^{χ}^{₁}^{χ′}^{₃} | g^{ν}^{₁}^{ν′}^{₂}^{ν′}^{₃}^{χ}^{₁}^{χ′}^{₂} | g^{ν}^{₁}^{ν′}^{₂}^{ν′}^{₃}^{χ}^{₁}^{χ′}^{₂}^{χ′}^{₃} |
| Fl′₄ | g^{ν}^{₁}^{ν′}^{₂}^{ν′}^{₃}^{ν′}^{₄}^{χ′}^{₂}^{χ′}^{₃}^{χ′}^{₄} | g^{ν}^{₁}^{ν′}^{₂}^{ν′}^{₃}^{ν′}^{₄}^{χ}^{₁}^{χ′}^{₃}^{χ′}^{₄} | g^{ν}^{₁}^{ν′}^{₂}^{ν′}^{₃}^{ν′}^{₄}^{χ}^{₁}^{χ′}^{₂}^{χ′}^{₄} | g^{ν}^{₁}^{ν′}^{₂}^{ν′}^{₃}^{ν′}^{₄}^{χ}^{₁}^{χ′}^{₂}^{χ′}^{₃} |
| Term | β₁ | β₂ | β₃ | β₄ |
| → | | | | |

Dynamic Secure Groups

It may be readily understood that groups may arbitrarily grow and shrink by sequential join and delete operations. Additionally, the join and delete operations may be simultaneously applied. This fluid nature of group size, with players coming and going, is why the term “dynamic” is used to describe such groups.

Distinct Secure Groups with Common Players

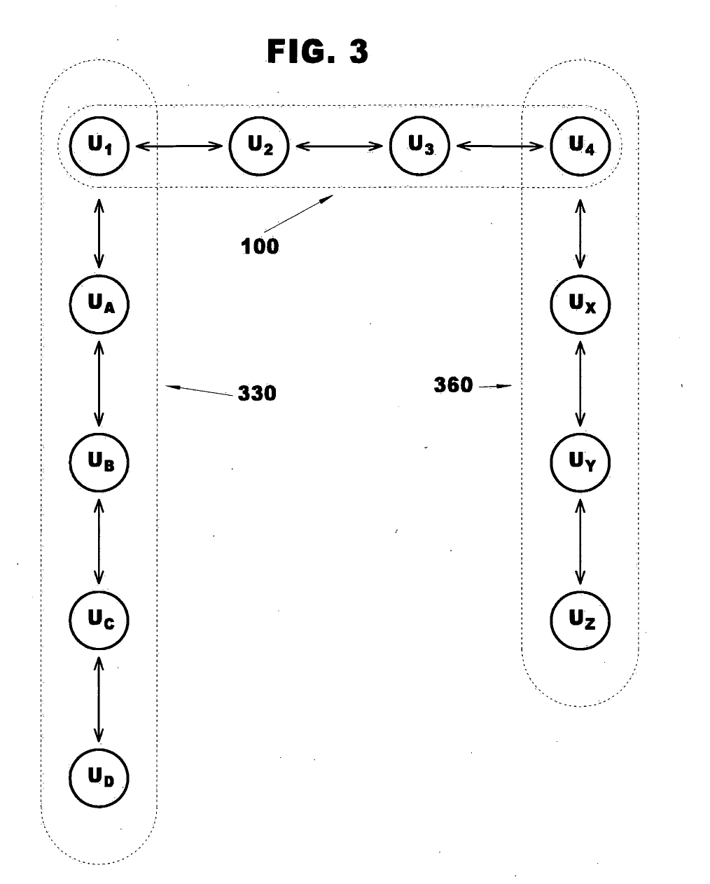

Refer now to FIG. 3, where players U₁ . . . U₄ form secure group 100. Another secure group 330 comprises players U₁ also in group 100, as well as U_{A} . . . U_{D}. Additionally, another secure group 360 comprises players U₄ also in group 100, as well as U_{X} . . . U_{Z}. Since player U₁ is a member of both groups 100 and 330, and since player U₄ is a member of both groups 100 and 360, it is possible for all players U_{A} . . . U_{D}, U₁ . . . U₄ and U_{X} . . . U_{Z} to all intercommunicate. Players U₁ and U₄ would be required to translate from one secure group cryptographic key to the other, or in a sense act as a secure transmission router. In this manner, different secure groups may be joined by common players. Although not illustrated in FIG. 3, a player may be in an unlimited number of groups, and group interconnection topologies are not limited.

Merging of Distinct Secure Groups with Common Players

Although not described in FIG. 3, some or all of the players U₁ . . . U₄, U_{A} . . . U_{D} and U_{X} . . . U_{Z} may be merged into either a separate or distinct union of the secure dynamic groups. These operations would be straightforward applications of the setup and/or join operations previously described above.

Alternatively, it is possible for some or all players U_{A} . . . U_{D} and U_{X} . . . U_{Z} to be joined to initial group 100 formed initially by players U₁ . . . U₄, thereby all players may intercommunicate directly by merging into one supergroup comprising players U_{A} . . . U_{D}, U₁ . . . U₄ and U_{X} . . . U_{Z}. This may be accomplished by straightforward application of the join operation described above. Alternatively, by taking advantage of already formed groups 330 and 360, a combination of join and refresh operations on the groups 330 and 360 may more rapidly be used to form a supergroup comprised of U_{A} . . . U_{D}, U₁ . . . U₄ and U_{X} . . . U_{Z}.

### Conclusion

All publications, patents, and patent applications mentioned in this specification are herein incorporated by reference to the same extent as if each individual publication or patent application were each specifically and individually indicated to be incorporated by reference.

The description given here, and best modes of operation of the invention, are not intended to limit the scope of the invention. Many modifications, alternative constructions, and equivalents may be employed without departing from the scope and spirit of the invention.

Arithmetic is in a finite cyclic group G=<alpha> of prime order beta. This group is assumed to be given a generator <alpha>. We assume that G, alpha, and beta are well-known. The group G should be a group on which the computational Diffie-Hellman problem is hard. There are three possibilities for such group: G=Z*p where p is a large prime number; G is an appropriate subgroup of Z*p; and G is an appropriate elliptic curve group.

Encryption methods may be instantiated by either the AES symmetric cipher or the bit-wise Boolean XOR-ing of the password with a public key.

1. A method for generating a cryptographic key by a player in a dynamic group, the method comprising:
a) receiving,
i) by a player Uₚ in a dynamic group with a first player U₁ and a last player Uₙ, where p>1,
ii) a previous upflow Flₚ₋₁ from a previous player Uₚ₋₁ in the dynamic group;
b) player Uₚ selecting a random value xₚ, and a random value vₚ; and
c) player Uₚ sending an outflow Flₚ, comprising information based on the random value xₚ, the random value vₚ, and the previous upflow Flₚ₋₁.

2. The method for generating a cryptographic key by a player in the dynamic group of claim 1, further comprising:
a) for a first player U₁ in the dynamic group:
i) player Uₚ selecting a random value x₁, and a random value v₁;
ii) setting an initial upflow Fl₁ comprising information based on the random value x₁, the random value v₁, and “g”, a generator of a finite group where a computational solution to a Diffie-Hellman problem is hard.

3. The method for generating a cryptographic key by a player in the dynamic group of claim 2, the sending step further comprising:
a) when player Uₚ is not the last player in the dynamic group, then:
i) player Uₚ sending an upflow Flₚ to a subsequent player Uₚ₊₁ in the dynamic group,
(1) the upflow Flₚ comprising the outflow Flₚ;
b) when player Uₚ is the last player in the dynamic group, then:
i) player Uₚ sending a downflow Flₙ to all other players in the dynamic group,
(1) the downflow Flₙ comprising the outflow Flₚ.

4. The method for generating a cryptographic key by a player in the dynamic group of claim 3 comprising:
a) forming a set of L players, U_{L}, leaving the dynamic group;
b) forming a set of R players, U_{R}, remaining in the dynamic group;
c) choosing a controller U_{C} from the remaining set of R players U_{R};
d) inputting, by controller U_{C}, the downflow Flₙ,
i) where the downflow Flₙ has one entry associated with each player in the dynamic group; and
e) sending a controller U_{C} downflow signal Fl_{C}′, comprising:
i) controller U_{C} sending the controller downflow Fl_{C}′ based upon a random value x_{C}, a random value v_{C}, and the downflow signal Flₙ,
(1) where each entry associated with the set of L players U_{L} leaving in the downflow signal Flₙ has been deleted.

5. The method for generating a cryptographic key by a player in the dynamic group of claim 3 comprising:
a) forming a set of J players to form a larger dynamic group U₁, . . . Uₙ, Uₙ₊₁, . . . , Uₙ₊ₖ, . . . , U_{n+J}, where 1≦k≦J;
b) sending an upflow Flₙ₊ₖ from each player Uₙ₊ₖ, to player Uₙ₊ₖ₊₁, where 1≦k≦J−1,
i) said upflow Flₙ₊ₖ based upon a random value xₙ₊ₖ, a random value vₙ₊ₖ, and the upflow Flₙ₊ₖ₋₁ received from player Uₙ₊ₖ₋₁; and
c) sending a downflow Fl_{n+J} by player U_{n+J}, based upon a random value x_{n+J}, a random value v_{n+J}, and the upflow Fl_{n+J-1}.

6. The method for generating a cryptographic key by a player in the dynamic group of claim 3 comprising:
a) choosing a refresher Uᵣ from the dynamic group U₁, . . . Uₙ;
b) inputting, by refresher Uᵣ, the downflow Flₙ,
i) where the downflow Flₙ has one entry associated with each player in the dynamic group; and
c) sending, by refresher Uᵣ, a refresher Uᵣ downflow Flᵣ′ based upon a random value xᵣ, a random value vᵣ, and the downflow signal Flₙ.

7. The method for generating a cryptographic key of claim 1 wherein said upflows are encrypted with a first encryption method.

8. The method for generating a cryptographic key of claim 3 wherein said downflows are encrypted with a second encryption method.

9. The method for generating a cryptographic key of claim 3 wherein said upflows and downflows are encrypted with a single encryption method.

10. An apparatus for generating a cryptographic key of claim 1.

11. The method for generating a cryptographic key of claim 1, wherein said steps are recorded on a computer readable medium.

12. The method for generating a cryptographic key of claim 1, wherein said upflows form a data structure transmitting through a computer readable medium.

13. The method for generating a cryptographic key of claim 1, wherein said steps are performed in a computer.

14. The method for generating a cryptographic key of claim 1, wherein said upflows are signal transmissions.

15. The method for generating a cryptographic key of claim 3, wherein said downflows are signal transmissions.

16. An apparatus for connecting a player to a dynamic group, the apparatus comprising a computer generating the cryptographic key of claim 1.

17. The method for generating a cryptographic key of claim 2 wherein said finite group is a finite cyclic group.

18. The method for generating a cryptographic key of claim 1, further comprising the step of:
a) limiting the dynamic group to a size of three or more parties.

19. A method for generating a cryptographic key by a player in a dynamic group, the method comprising:
a) providing a candidate player Uₚ wishing to be a party for a dynamic group with a first player U₁ and a last player Uₙ, where p>1,
b) means for connecting player Uₚ to the dynamic group.

20. The method for generating a cryptographic key by a player in a dynamic group of claim 19, the method further comprising:
a) means for removing a set of L players, U_{L}, leaving the dynamic group.

21. The method for generating a cryptographic key by a player in a dynamic group of claim 19, the method further comprising:
a) means for generating a downflow by the last player Uₙ in the dynamic group to the other players in the dynamic group.

22. The method for generating a cryptographic key by a player in a dynamic group of claim 19, the method further comprising:
a) means for joining a set of J player to the dynamic group.

23. A method for generating a cryptographic key, the method comprising:
a) providing a plurality of players U₁, . . . Uⱼ, . . . , Uₙ, where 1≦j≦n;
b) providing a generator “g”;
c) initially sending an upflow signal Fl₁ from player U₁ to player U₂,
i) said initial upflow signal based upon generator “g”, a random value x₁, and a random value v₁;
d) sending an upflow signal Flᵢ from each player Uᵢ, to player Uᵢ₊₁, where 2≦i<n−1,
i) said upflow signal Flᵢ based upon a random value xᵢ, a random value vᵢ, and the upflow signal Flᵢ₋₁ received from player Uᵢ₋₁;
e) sending a downflow signal Flₙ by player Uₙ, based upon a random value xₙ, a random value vₙ, and the upflow signal Flₙ₋₁;
f) calculating a cryptographic key by player Uⱼ, where 1≦j≦n−1, said calculating step comprising:
i) receiving the downflow signal Flₙ,
ii) calculating a cryptographic key based on the random value xⱼ and the received downflow signal Flₙ.

24. The method for generating a cryptographic key of claim 23 further comprising;
a) calculating a cryptographic key by player Uₙ, said calculating step comprising:
i) receiving the downflow signal Flₙ,
ii) calculating a cryptographic key based on the random value xₙ and the received downflow signal Flₙ.

25. The method for generating a cryptographic key of claim 23 further comprising:
a) calculating a cryptographic key by player Uₙ based on the random value xₙ and the upflow signal Flₙ₋₁.

26. The method for generating a cryptographic key of claim 23 wherein said generator providing step,
a) “g” is the generator of a finite cyclic group where a computational solution to a Diffie-Hellman problem is hard.

27. The method for generating a cryptographic key of claim 26 wherein said upflows are encrypted with a first encryption method.

28. The method for generating a cryptographic key of claim 26 wherein said upflows are not encrypted.

29. The method for generating a cryptographic key of claim 26 wherein said downflows are encrypted with a second encryption method.

30. The method for generating a cryptographic key of claim 26 wherein said downflows are not encrypted.

31. The method for generating a cryptographic key of claim 26 wherein said upflows and downflows are encrypted with a single encryption method.

32. The method for generating a cryptographic key of claim 26 wherein said providing step plurality of players is a dynamic set of players.

33. The method for generating a cryptographic key of claim 26 comprising:
a) forming a set of L players, U_{L}, leaving the plurality of players;
b) forming a set of R players, U_{R}, remaining in the plurality of players;
c) choosing a controller U_{C} from the remaining set of players U_{R};
d) inputting, by controller U_{C}, the downflow signal Flₙ,
i) where the downflow signal Flₙ has one entry associated with each player in the plurality of players; and
e) sending a controller U_{C} downflow signal Fl_{C}′, comprising:
i) controller U_{C} sending the controller downflow signal Fl_{C}′ based upon a random value x_{C}, a random value v_{C}, and the downflow signal Flₙ,
(1) where each entry associated with the set of L players U_{L} leaving in the downflow signal Flₙ has been deleted.

34. The method for generating a cryptographic key of claim 26 comprising:
a) forming a set of J players, the plurality of players to form a larger plurality of players U₁, . . . Uₙ, Uₙ₊₁, . . . , Uₙ₊ₖ, . . . , U_{n+J}, where 1≦k≦J;
b) sending an upflow signal Flₙ₊ₖ from each player Uₙ₊ₖ, to player Uₙ₊ₖ₊₁, where 1≦k≦J−1,
i) said upflow signal Flₙ₊ₖ based upon a random value xₙ₊ₖ, a random value vₙ₊ₖ, and the upflow signal Flₙ₊ₖ₋₁ received from player Uₙ₊ₖ₋₁; and
c) sending a downflow signal Fl_{n+J} by player U_{n+J}, based upon a random value x_{n+J}, a random value v_{n+J}, and the upflow signal Fl_{n+J-1}.

35. The method for generating a cryptographic key of claim 26 comprising:
a) choosing a refresher Uᵣ from the plurality of players U₁, . . . Uₙ;
b) inputting, by refresher Uᵣ, the downflow signal Flₙ,
i) where the downflow signal Flₙ has one entry associated with each player in the plurality of players; and
(1) sending a refresher Uᵣ downflow signal Flᵣ′ based upon a random value xᵣ, a random value vᵣ, and the downflow signal Flₙ.

36. A method for generating a cryptographic key for a dynamic set of players, comprising:
a) initiating a 0^{th} upflow signal Fl₀;
b) setting up a dynamic set of players U₁, . . . , Uₙ, having a number n of players, where n varies dynamically;
c) Uₙ broadcasting a downflow signal Flₙ to the dynamic set of players; and
d) adjusting the dynamic set of players and the number n of players.

37. The method for generating a cryptographic key for a dynamic set of players of claim 36, further comprising:
a) closing the dynamic set of players when n becomes zero.

38. The method for generating a cryptographic key for a dynamic set of players of claim 36, wherein said initiating step 0^{th} upflow signal Fl₀ is based upon a generator “g” of a finite cyclic group wherein a computational solution to a Diffie-Hellman problem is hard.

39. The method for generating a cryptographic key for a dynamic set of players of claim 36, wherein said setting up step further comprises:
a) for players Uᵢ, where 1≦i<n−1:
i) sending an upflow signal Flᵢ from each player Uᵢ, to player Uᵢ₊₁, where 1≦i<n−1,
ii) said upflow signal Flᵢ based upon a random value xᵢ, a random value vᵢ, and the upflow signal Flᵢ₋₁ received from player Uᵢ₋₁;
b) for player n:
(1) the downflow signal Flₙ based upon a random value xₙ, a random value Vₙ, and the upflow signal Flₙ₋₁ received from player Uₙ₋₁.

40. The method for generating a cryptographic key for a dynamic set of players of claim 39, wherein said setting up step further comprises:
a) sending the downflow signal Flⱼ by player Uⱼ, based upon a random value xⱼ, a random value vⱼ, and the upflow signal Flⱼ₋₁.

41. The method for generating a cryptographic key for a dynamic set of players of claim 40, further comprising:
i) calculating a cryptographic key by player Uⱼ, based on the downflow signal Flₙ, the random value xⱼ, and the random value vⱼ.

42. The method for generating a cryptographic key for a dynamic set of players of claim 40, wherein said adjusting step further comprises:
a) monitoring within the dynamic set of players to determine a set of L players, U_{L}, leaving;
b) monitoring outside the dynamic set of players to determine a set of J players, U_{J}, joining;
c) dynamically joining players to increase the number of the dynamic set of players;
d) dynamically removing players to decrease the number of the dynamic set of players.

43. The method for generating a cryptographic key for a dynamic set of players of claim 42, wherein said dynamically removing step further comprises:
a) choosing a controller U_{C}, where U_{C} is not leaving the dynamic set of players;
b) inputting, by controller U_{C}, the downflow signal Flₙ,
i) where the downflow signal Flₙ has one entry associated with each player in the dynamic plurality of players; and
c) sending a controller U_{C} downflow signal Fl_{C}′, comprising:
i) controller U_{C} sending the controller downflow signal Fl_{C}′ based upon a random value x_{C}, a random value v_{C}, and the downflow signal Flₙ,
(1) where each entry associated with the set of L players U_{L} leaving in the downflow signal Flₙ has been deleted.

44. A method for generating a cryptographic key, the method comprising:
a) providing a plurality of players U₁, . . . , Uⱼ, . . . , Uₙ, where 1≦j≦n;
b) forming an upflow signal Flᵢ by player Uᵢ, where 1≦i<n, said upflow forming step comprising:
i) receiving an incoming signal flow Flᵢ₋₁;
ii) decrypting Flᵢ₋₁ using a first symmetric key cryptosystem, D_{pw}, into a plaintext message Xᵢ₋₁, wherein
(1) Xᵢ₋₁ is comprised of Xᵢ={X₁, . . . Xᵢ₋₃, Xᵢ}, having i−1 terms;
iii) generating a first random value, xᵢ, and a second random value vᵢ;
iv) forming a new plaintext message Xᵢ:=Φ(Xᵢ₋₁, xᵢ, υᵢ), comprised of i terms; and
v) encrypting the new plaintext message Xᵢ with the first symmetric key cryptosystem ε_{pw} into the upflow signal Flᵢ; and
vi) transmitting said outgoing signal Flᵢ to player Uᵢ₊₁;
c) forming a downflow signal Flₙ by player Uₙ, by:
i) receiving an incoming signal flow Flₙ₋₁;
ii) decrypting Flₙ₋₁ using the first symmetric key cryptosystem, D_{pw}, into a plaintext message Xₙ₋₁;
iii) generating a first random value, xₙ, and a second random value vₙ;
iv) forming a new plaintext message Xₙ′:=Φ′(Xₙ₋₁, xₙ, υₙ), comprised of n terms;
v) encrypting the new plaintext message Xₙ′ with a second symmetric key cryptosystem ε_{pw}′ into the downflow signal Flₙ; and
vi) broadcasting the downflow signal Flₙ;
d) calculating a cryptographic key by player Uⱼ, where 1≦j≦n, said calculating step comprising:
i) receiving the downflow signal Flₙ;
ii) decrypting the downflow signal Flₙ using a fourth symmetric key cryptosystem, D_{pw}′, into a plaintext message Xₙ′, comprised of n terms;
iii) raising the j^{th} term of Xₙ′ to the xⱼ^{th} power to calculate the cryptographic key.

45. The method of claim 44 wherein said first symmetric key cryptosystem and said second symmetric key cryptosystem are identical.

46. The method of claim 44 wherein said first symmetric key cryptosystem and said second symmetric key cryptosystem are different.

47. A method for generating a cryptographic key, the method comprising:
a) providing a plurality of players U₁, . . . Uⱼ, . . . , Uₙ, where 1≦j≦n;
b) providing a generator “g”;
c) sending an initial upflow signal Fl₁ from player U₁ to player U₂,
i) said initial upflow signal sending step based upon generator “g”, a random value x₁, and a random value v₁;
d) sending an upflow signal Flᵢ from each player Uᵢ, to player Uᵢ₊₁ where 2≦i<n−1,
i) said upflow signal sending step based upon an incoming signal flow Flᵢ₋₁, a random value xᵢ, and a random value vᵢ;
e) sending a downflow signal Flₙ by player Uₙ,
i) said downflow signal step based upon an incoming signal flow Flₙ₋₁, a random value xₙ, and a random value vₙ;
f) calculating a cryptographic key by player Uⱼ, where 1≦j≦n−1, said calculating step comprising:
i) receiving the downflow signal Flₙ,
ii) calculating the cryptographic key based on the random value x; and the received downflow signal Flₙ.
g) calculating a cryptographic key by player Uₙ based on the random value xₙ and the incoming signal flow Flₙ₋₁.

48. The method for generating a cryptographic key of claim 47, wherein said generator providing step,
a) “g” is the generator of a finite cyclic group where the Diffie-Hellman problem is hard.
